(19) United States
(12) Patent Application Publication
(10) Pub. No.: US 2002/0188575 A1
(43) Pub. Date: Dec. 12, 2002

(54) Advanced wireless phone system

(76) Inventor: Charles C. Freeny JR., Dallas, TX (US)

Correspondence Address: DUNLAP, CODDING & ROGERS P.C., PO BOX 16370, OKLAHOMA CITY, OK, 73114, US

(21) Appl. No.: 10/212,645

(22) Filed: Aug. 2, 2002

Related U.S. Application Data
(63) Continuation of application No. 09/325,500, filed on Jun. 3, 1999, now abandoned.

(51) Int. Cl. G06F 17/60

(52) U.S. Cl. 705/72

(57) ABSTRACT

A Wireless Phone/pager system is modified to allow an owner to have proximity services such as toll tag access, ATM dispensing, gas pump dispensing, store credit card checkout, television remote control, garage door access, and more services using their wireless Phone/pager. The modification is accomplished in such a way that the existing wireless phone/pager/palm computer systems and the proximity device processing units require very little modification but produce a truly Advanced Wireless Phone/pager/palm computer System (AWPS). The AWPS can be appended in a seamless manner to the existing wireless communication and proximity service provider systems in current use. The new system virtually eliminates the need to carry multiple credit cards and access devices such as toll tags. Another feature of the invention is the built-in finger print detector unit which automatically provides unique owner codes which can be used to either replace or supplement the PIN codes usually required with the proximity service providers. The system may also combine multiple proximity billing services with the Phone/pager service provider, i.e., another convenience that would be greatly appreciated by the consumer.

### CROSS-REFERENCE TO RELATED APPLICATIONS

This is a continuation of U.S. Ser. No. 09/325,500, entitled Advanced Wireless Phone System, and filed on Jun. 3, 1999, the entire content of which is hereby incorporated herein by reference.

### STATEMENT REGARD FEDERALLY SPONSORED RESEARCH AND DEVELOPMENT

Not Applicable.

### BACKGROUND OF THE INVENTION

The wireless phone/pager industry is rapidly changing the way people are starting to communicate. New digital phones, such as the NOKIA 9000 communicator series and the Qualcomm pdQ smartphone, are incorporating into phone computers more and more pager and internet service provider services, along with limited computer capabilities for the customer. The legacy “land line and cable” phone system communication methods are rapidly being replaced or supplemented by these new digital wireless phones. The reason is simple; the mobile phones are both more convenient and, in many cases, becoming less expensive than legacy systems. This is especially true in many other countries that had limited or no legacy phone service, because the cost of the hardwire infrastructure was too great.

Before long, the new wireless phones may become a necessity for almost all individuals, even as those individuals still use conventional phones at home or in the office. The mobile office is truly becoming a way of life and phone makers are competing with computer makers for the “mobile office” market. However, all of these new, competing “digital wireless phones with built-in computers” and “palm computers with built-in phone/pager” systems are still focusing on bringing the customer a portable unit with longer life, E-Mail delivery capability, onboard phone book capability, more computer functions, roaming and other similar conveniences that used to require a computer and modem connected to a legacy phone system.

A Mobile Small Office-Home Office (SOHO) market is emerging and it is not at all like the computer industry envisioned several years ago, or the wireless phone/pager industry envisioned. At the same time, the communication bandwidth infrastructure such as Fiber Optics Cables, Low Orbit Satellites, Gigafrequency Microwave systems, is allowing the wireless phone/pager system to grow at a rate it never anticipated and many communication service providers are struggling just to handle new customers.

While digital technology has been fueling the wireless communication explosion, it also has been fueling rapid advances in other areas, such as credit card systems (debit cards, smart cards, etc.), e-commerce (ATM,s, WWW virtual stores), rapid gas delivery systems, rapid store check out systems, building access systems, and automated toll booth systems. These other areas will be referred to as the “proximity services” since in all cases the user must be close to a terminal (or proximity service provider) of some type to be serviced.

To date, the advances in the wireless industry, computer industry, and the multiple proximity service industry, have been vertical advances (improvements in the older systems) brought on by the rapid size and cost reductions in digital technology. As with most technology advances, there is normally a price to pay for this convenience. The price to pay with all of these ancillary proximity service systems has been, for the most part, the inconvenience of having to carry multiple cards or other access devices along with the codes required for maintaining a customer's privacy.

The inventor thinks it is now time to start replacing the multi-redundant system infrastructure with multiple integrated systems that allow a person to have all the modern rapid access conveniences without having to carry many cards or devices. It is to such a system that the present invention is directed.

This invention combines the advances in the wireless communication digital devices and infrastructure with the demands of the many proximity service providers, such as rapid access and card systems proliferating the economy, to reduce the number of items which an individual must carry to interface with these systems. This invention relates to a system that incorporates all of the rapid access signaling and card requirements into a portable electronic communication device, such as a wireless phone, wireless pager or a palm computer. With the described invention, a single device may allow both mobile SOHO services to be used in combination with the vast number of proximity services offered by proximity service providers, such as access and credit card services that meet the individual or business needs.

### SUMMARY OF THE INVENTION

The new advanced wireless phone/pager system (AWPS) described herein combines the basic infrastructure and protocols to interface bi-directionally with proximity service providers, such as existing card and signaling access systems into a portable electronic device, such as a digital phone/pager capable of communicating bi-directionally with a communication service provider. The AWPS may also allow the means to decode these features to be placed on top of the legacy proximity service providers, such as the access and credit card reader systems. The new system refers to one key subsystem element as an Advance Wireless Phone/Pager (AWP unit or portable electronic communication device) to distinguish it from the Legacy wireless phone/pager, and the other key subsystem element as an Advanced Proximity Transmitter Receiver Unit (APTRU) to distinguish the portion added by this invention from the existing access and credit card reader systems functions already incorporated into these proximity service providers. The invention allows all of the card and other access device codes (personal information code) to be incorporated or stored in the AWP unit by remote control under the control of the proximity service provider although other suitable methods or apparatus can also be utilized, such as a keyboard.

The invention modifies the existing proximity service providers in a manner such that the existing proximity service providers can still use the regular access devices such as credit cards and toll tags and also communicate with the AWP unit. The small added cost to modify the existing proximity service units will be quickly paid for by the increase in customer usage. A nice feature of the AWPS is that all of the access signaling to the proximity service provider can be done in a low power mode which does not decrease the life of the SOHO functions provided the AWP unit owner in todays legacy communication services.

That is, the AWP unit described in this invention may have a dual power capability (or other suitable system of bi-directionally communicating with the proximity service provider and the communication service provider) which can be used to service all of the ancillary access and other close proximity services that can become part of the AWP unit in the future. A notable one is automatic vehicle or individual location monitoring services (note AVM systems currently exist using cell phones but they operate in the high power mode and the resolution is no better than the wireless phone cell location distances). The communication service provider such as Sprint, SWBT, or Nextel could also be the billing company for many of these proximity service providers currently sending out separate bills. This would greatly lower the cost of collections currently being done by Highway Tolling authorities, Airport Tolling authorities, parking lot companies, and the numerous credit card companies. Such a consolidated collection system would greatly increase the convenience to the customer and lower the cost to the various proximity service providers. Thus one embodiment of the AWPS invention allows graceful and convenient conversion into the information age using an approach that allows gradual replacement of the legacy access and proximity signaling systems with a universal multi purpose mobile communication device. Equally important the new system allows a seamless conversion to a universal worldwide system that each country can use to eventually phase out their existing proximity service providers, such as the limited and specialized access and credit systems which will make travelling much more convenient.

The AWP unit can also incorporate the “alpha-numeric” worldwide communication features described in a co-pending patent application (Ser. No. 60/121,193), the disclosure of which is hereby incorporated herein by reference. That is, there will be no need for those who purchase AWP unit's to learn the various state and country legacy communication and access systems after the AWU's are incorporated on top of the legacy operating systems. Thus in the future only one customer device will be required to have multiple services (for example, up to 20 services) now requiring separate devices, and customer billing systems. The AWP unit is also suited for a third feature involving the code portion of the operating system. The AWP unit is ideally suited to generate a unique owner code which can be automatically inserted from the AWP unit using a fingerprint converter unit built into the AWP unit. That is, an owner fingerprint code would always be available when the owner was operating the AWP unit and could be used as the only security or additional security to a PIN number to greatly reduce both credit card fraud and illegal entry into buildings. The fingerprint detector unit can also be incorporated into other communication devices, such as legacy non-wireless phones, to provide automated security features. Such automated security features may become necessary to prevent fraud in the many growing number of services, such as used in stock trading by computer (see co-pending application Ser. No. 08/970,769).

### BRIEF DESCRIPTION OF THE SEVERAL VIEWS OF THE DRAWING

FIG. 1 shows a diagram depicting the major AWPS Subsystem Elements. Four types of APTRU units are shown representing the most common proximity service providers, such as access and credit card systems in use today. Also the four most common mediums utilized by communication service providers for connecting phones/pagers and data processing centers today are shown including the Internet link. A single AWP unit is shown in FIG. 1 interfacing with all of these systems.

FIG. 2 shows the AWP unit and the signal flow logic in more detail. Those portions required to turn an existing Wireless digital Phone/pager are shown grouped separately from the existing elements available in state of the art digital wireless phone/pager. The existing elements are grouped and referred to as the Existing Legacy phone/pager Capabilities.

FIG. 3 shows a generic conversion process flow diagram example that is at the heart of the APTRU processing unit that interfaces with the existing legacy proximity service processing units of the various types shown in FIG. 1.

FIG. 4 shows the elements and logic flow diagram for a Toll access system.

FIG. 5 shows the elements and logic flow diagram for an ATM dispensing system.

FIG. 6 shows the elements and logic flow diagram for a Gas Pump access system.

FIG. 7 shows the elements and logic flow diagram for a store checkout system.

FIG. 8 shows the elements and logic flow diagram for adding the finger print detector unit to the wireless AWP unit.

FIG. 9 shows a schematic view of a geographical territory which has been characterized as a local area and a roaming area.

FIG. 10 shows the elements of logic flow diagram for a telephone dialing system constructed in accordance with the present invention.

### DETAILED DESCRIPTION OF INVENTION

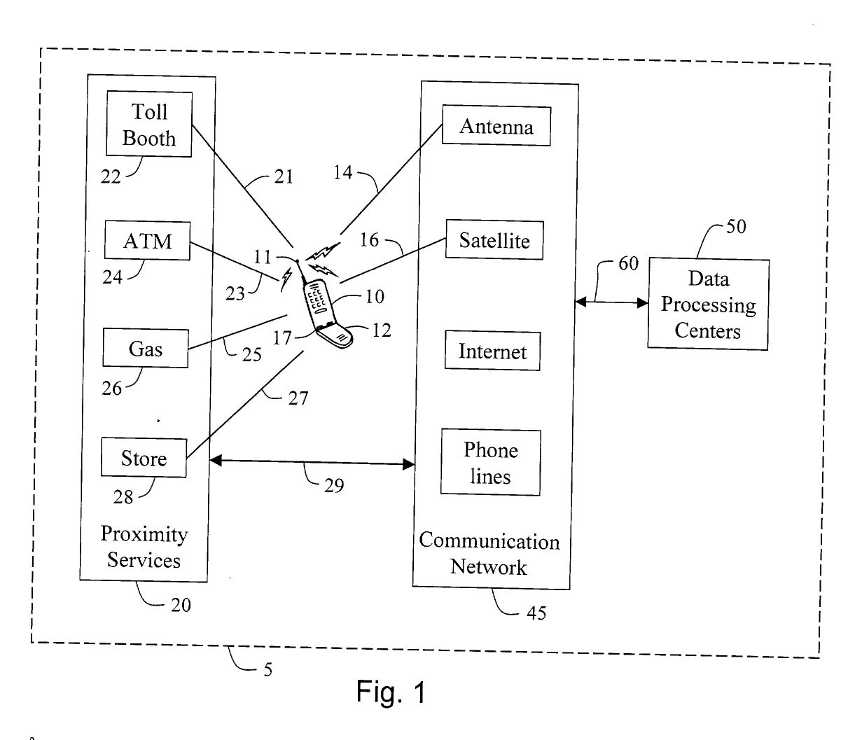

Referring to the FIG. 1, an AWPS 5 is depicted and is comprised of an AWP unit or portable electronic communication device 10, connected to communication service providers 45, via a communication unit 11 supported by the AWP unit 10 and capable of communicating with wireless ground station or satellite links 14 or 16 via a first signal type. The AWP unit 10 includes a portable housing 17. The portable housing 17 of the AWP unit 10 supports the communication unit 11 and other components of the AWP unit 10, including the memory of the AWP unit 10. The links 14 or 16 can be bi-directional communication links. The communication service providers 45 can be telephone communication companies, such as AT&T, SBC Communications, Air Touch Communications, NexTel, or the like. The AWP units 10 are also connected to the various types of proximity service providers 20 by the communication unit 11 and with a second signal type.

The first signal type can be a high-power radio frequency type signal (which is sometimes referred to herein as a “high power mode”) utilized by wireless telephones and pagers, for example. The second signal type can be a low power radio frequency type signal (which is sometimes referred to herein as a “low power mode”) utilized in communication systems involving relatively short distances of less than one-mile, for example. For example, the second signal type can be low power radio frequency signal, or a light signal generated by an LED, or a communication signal transmitted over a cable, for example. The first and second signal types may be the same or different signal types depending on the particular application of the AWPS 5.

The proximity service providers 20 can be access and credit card units such as a toll booth unit 22, an ATM unit 24, a gas station pump 26, and a store checkout station 28. Although not specifically shown in FIG. 1, the proximity service provider 20 can also be a television or other device having a remote control communication system, a garage door opener or other proximity service providers which receive signals transmitted from a relatively short distance away as discussed above.

The Toll Booth unit 22 is shown being wireless connected to the AWP unit 10 via link 21 and communication unit 11. The ATM unit 24 is shown being wireless connected to the AWP unit 10 via link 23 and communication unit 11. The Gas Station Pump 26 is shown being wireless connected to the AWP unit 10 via link 25 and communication unit 11. The Store check out station 28 is shown being wireless connected to the AWP unit 10 via link 27 and communication unit 11. The links 21, 23, 25, and 27 can be any suitable bi-directional communication link and the communication unit 11 can be any suitable bidirectional communication device, for example. All of these proximity service providers 20 are connected to their respective Data processing Business centers, if any, via link 29 to the communication service provider 45 and then to the business center 50 thereof via link 60. By way of example an AWP unit owner may be using their AWP unit 10 via link 14 in one of the normal communication modes such as voice or data delivery and at the same time being granted access through a toll booth 22 by the same AWP unit 10 (simultaneous dual signaling mode).

The wireless cellular network links are shown in 45 and they direct the AWP unit 10 communication call charges to the billing data processing centers 50 via link 60. The toll booth 22 charges can be directed to this same central billing system 50 via standard phone lines 29 and connection 60 or they can be billed separately using the old legacy toll booth billing system.

In FIG. 1 the method to automatically insert a unique code generated from the AWP unit 10 owner starts with the fingerprint detector unit 12. The finger print detector unit 12 generates a unique code that can be automatically used to provide security to the proximity service providers 20 or used as supplemental security to other codes such as PIN numbers currently required by some proximity service providers 20.

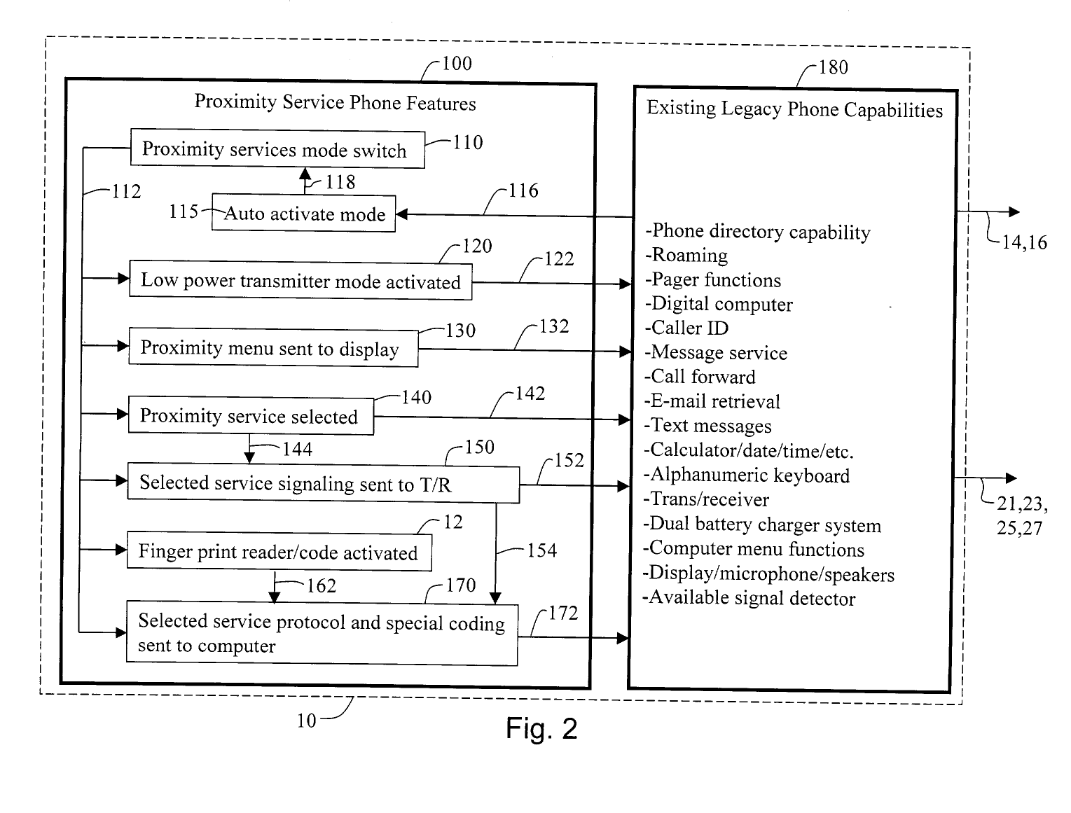

In FIG. 2 the AWP unit 10 of FIG. 1 is further described in terms of various proximity service features 100 that utilize the existing legacy wireless phone/pager capabilities 180 when the AWP unit 10 is embodied in a wireless telephone (which includes a telephone transmitter unit, a telephone receiver unit, a microphone for receiving voice or data, and a speaker or display for outputting information received from the telephone transmitter unit from the communication service provider) or pager (which includes a portable housing supporting a receiver unit for receiving information from the communication service provider). The making and using of the existing legacy phone capabilities 180 are well known in the art. The existing capabilities 180 include the ability to insert names and phone numbers into the phone/pager computer memory following menu instruction shown on the display. This same process may be used in the new invention as one means to insert personal information codes, such as credit card numbers, Personal Identification numbers and access codes into the AWP unit 10 for use with the various proximity services offered by the proximity service provider 20. Another means to insert personal information codes into the AWP unit 10 is by letting the proximity service provider 20 insert the personal information codes in a secure fashion with the encryption means the proximity service provider 20 chooses. Thus in some cases the user can insert the personal information codes, such as proximity service codes, and in other cases the proximity service provider 20 inserts the personal information codes, such as proximity service codes.

Examples of uses of the present invention where it may be desirable to permit the proximity service provider 20 to insert the personal identification codes into the AWP unit 10 are security access codes, smart cards holding money, debit cards, and maybe even credit cards, except for the PIN numbers which may be inserted by the user via an input unit such as the alphanumeric keyboard included in the existing legacy phone capabilities 180.

The new services 100 include a proximity services mode switch 110 which can be activated manually or automatically via an auto activate mode unit 115 which would be turned on via link 116 when a signal was received by a T/R available signal detector unit located in the existing legacy phone capabilities 180. Once the Advanced Proximity Transmitter Receiver Unit (APTRU) of one of the proximity service providers 20 is detected by the AWP unit 10 via one of the lines 21, 23, 25, or 27 while in the auto activate mode, the unit 115 turns on the unit 110 via link 118 and a proximity service unit 140 then selects the correct proximity service automatically.

The selection of the manual or automatic mode can be one of the menu setup options available in a proximity menu unit 130 and can be accomplished by the user manipulating the alphanumeric keyboard included in the existing legacy phone capabilities 180. The proximity menu unit 130 represents a new service capability added to the main macro setup menu of the legacy computer menu functions shown in the existing legacy phone capabilities 180. Once the proximity services mode switch 110 is activated either manually or automatically as just described, the switch 110 causes a mode of operation for communicating with the proximity service provider 20 to be activated by a unit 120 via line 122 sent to the transmitter/receiver located in 180. The unit 120, for causing the mode of operation for communicating with the proximity service provider 20 to be activated, is shown in FIG. 2 as a “low power transmitter mode” by way of example.

Also the desired proximity service is selected either automatically or manually via a unit 140 and then a selected service signaling unit 150 is activated via link 144, and the legacy unit 180 is notified via link 142. In turn the unit 150 notifies the legacy unit 180 or the type of service signaling to expect and simultaneously notifies the selected service protocol unit 170 via line 154.

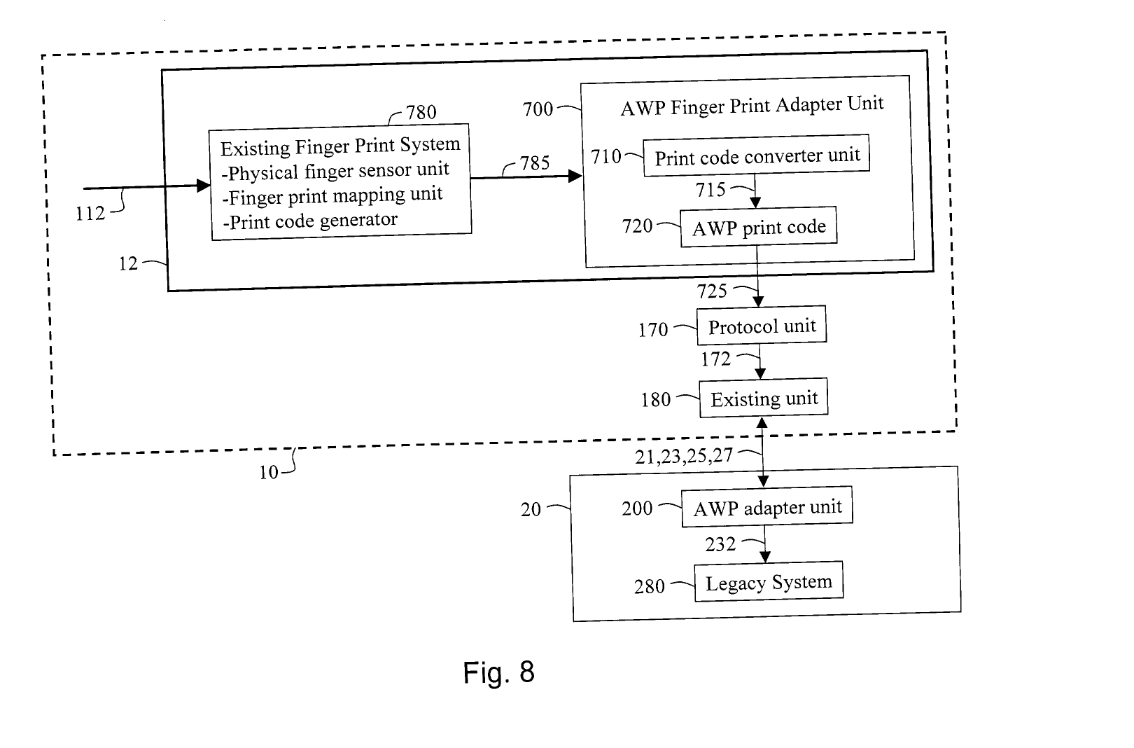

The fingerprint detector unit 12 can be activated in all selected service modes and feeds the users fingerprint code into the protocol unit 170 via line 162 as described more fully in connection with FIG. 8.

Finally all of the proper protocol information associated with the selected service such as Toll Tag, parking lot entry, ATM dispensing, Gas pump dispensing, automatic vehicle monitoring, and others that may be provided by the AWP unit 10 to the proximity service provider 20 is stored in unit 170. The predetermined protocols associated with the selected service is sent over to the legacy computer system in the existing legacy phone capabilities 180 via link 172 for proper processing of the security and other validation functions prior to transmission to one of the proximity service providers 20 via one of the lines 21, 23, 25 or 27.

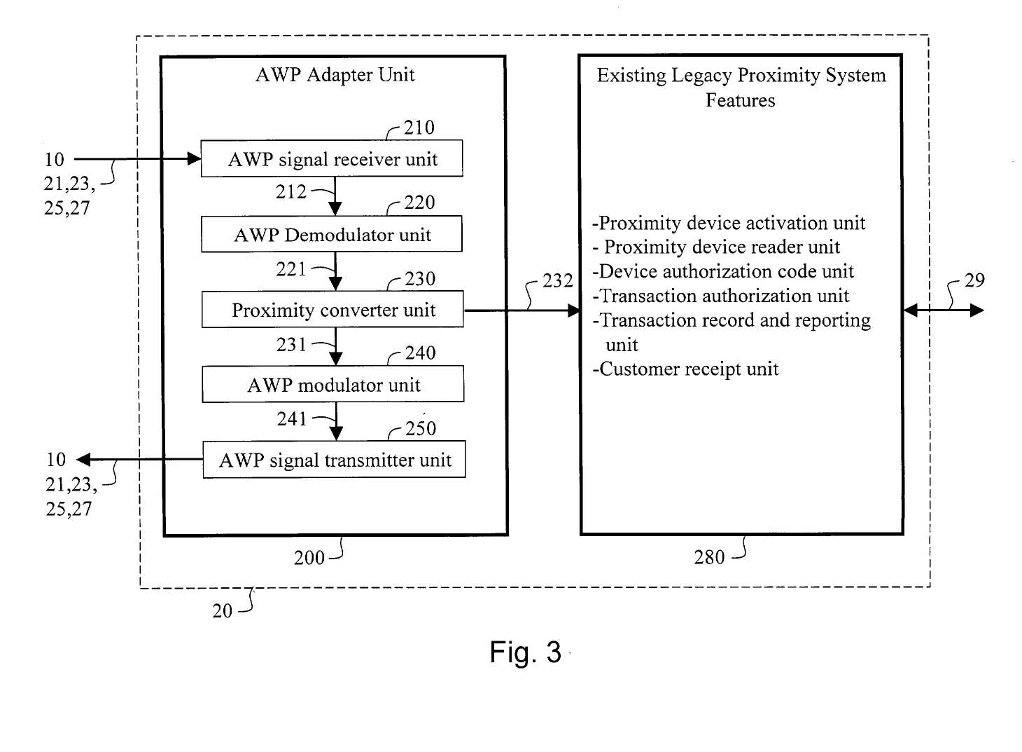

The actual data processing is performed by a proximity service program selected by signal 142 and stored in the legacy digital communication computer located in the existing legacy phone capabilities 180 while the AWP unit 10 is in communication with one of the proximity service providers 20 more fully described in FIGS. 3 to 8. In accordance with the present invention, a proximity service program is stored in the existing legacy phone capabilities 180 of the AWP unit 10. The proximity service program is associated with each of the proximity services offered by the proximity service provider 20.

In one embodiment, the low power signaling (or other type of communication with the proximity service provider 20) via one of the links 21, 23, 25 or 27 can operate while the existing legacy phone capabilities 180 of the AWP unit 10 operates in the normal high power communication mode (or other suitable type of communication mode) via one of the links 14 or 16 in between the AWP unit 10 and legacy unit 180 high power signal bursts. This is referred to as the simultaneous dual power mode. In the simultaneous dual power mode, the user can be receiving messages (voice or data) on the AWP unit 10 from the communication service provider 45 while the AWP unit 10 is communicating with one of the proximity service providers 20 to effect a transaction, such as when the user is driving through a toll gate or paying for groceries at a checkout counter or utilizing some other proximity service provider 20.

The additional security provided by a built in finger print detector unit 12, provides a system that is secure and practical in the 21^{st} century. However this feature could just be an option.

The description provided above will allow any one skilled in the art to quickly design a modification to an existing legacy Wireless phone/pager or palm top computer such as a Nokia 9000 wireless phone/pager, or an advanced 3com palm pilot III mobile computer respectively (these do not have phone/pager capability but may in the near future).

One of the more important benefits of the invention is that the modifications required to add the AWP unit 10 capability to the existing proximity service providers 20 such as mentioned above is even simpler than the modifications required to the existing digital wireless phone/pager or palm top computers. All that is required is a very simple rf, or LED Proximity Transmitter and Receiver Unit or other bi-directional communication device, such as a physical docking or plug-in station for the AWP unit 10, that includes a proximity converter unit that interfaces the AWP unit T/R signals with the existing legacy proximity service provider communication unit with the correct protocols. In FIG. 3 such a generic APTRU 20 is shown in terms of the AWP adapter unit 200 and the existing generic legacy system functions 280. The legacy system functions 280 include an input unit (not shown) for reading at least one personal information code from a hard copy (e.g. credit card, debit card or the like) capable of being carried by an individual. The AWP adapter unit 200 has an AWP unit signal receiver unit 210 that receives the AWP unit 10 signals via one of the links 21, 23, 25 or 27.

The receiver detected signals are sent to the demodulator unit 220 via line 212. The demodulated signals are then sent to the proximity converter unit 230 via line 221 for interfacing with the legacy system unit 280 via line 232. Signals going back to the AWP unit 10 are first sent from the legacy unit 280 via line 232 to the proximity converter unit 230. The signal is then converted into the proper form for transmission and sent to the AWP modulator unit 240 via line 231. The modulated signal is then sent to the low power AWP signal transmitter unit 250 which transmits back to the AWP unit 10 via one of the links 21,23,25, or 27.

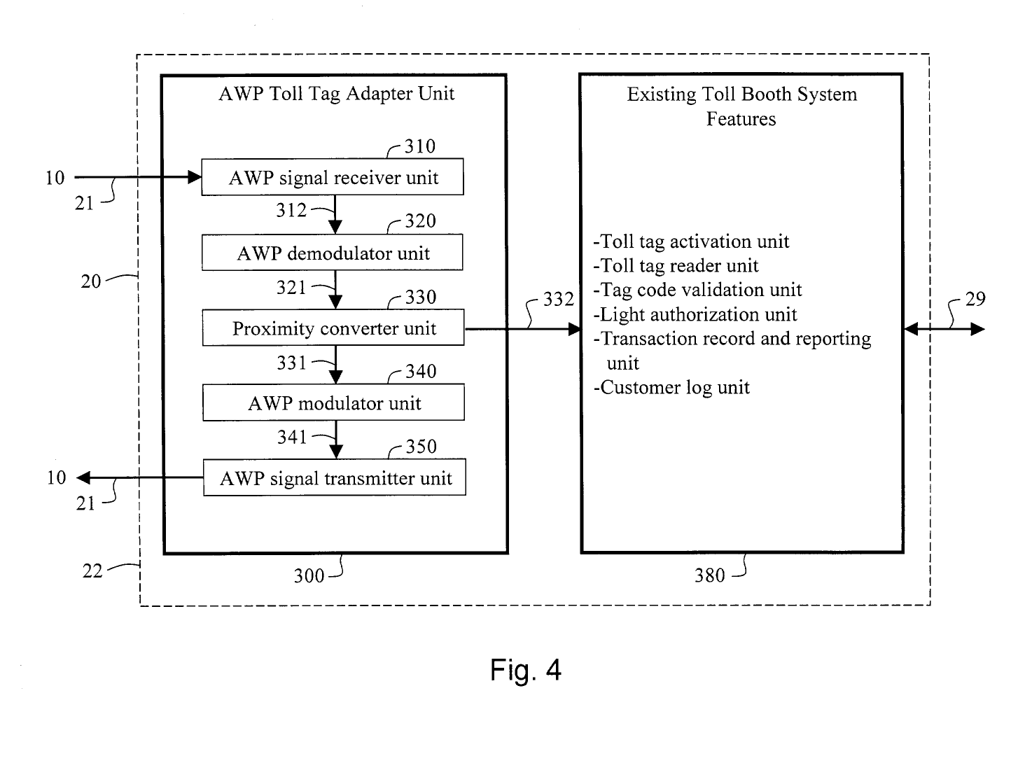

In FIGS. 4 through FIG. 7 the APTRU units for the four proximity service providers 20 used in the invention description are presented. The numbering systems have been changed to distinguish each of the four proximity service providers 20 and the legacy function for each type proximity service provider 20 are given in each of the figures legacy unit. Also the specific communication link 21, 23, 25 or 27 is shown corresponding to the service center depicted in FIG. 1. The description of signal and logic flow is similar to that described in connection with the generic unit of FIG. 3 and will not be repeated for the sake of brevity.

FIG. 8 depicts how the finger print detector unit 12 signals are generated and flow between the AWP unit 10 and the proximity service provider 20 of the AWPS 5. When the finger print detector unit 12 is activated by the proximity services mode switch 110 via line 112 then a finger print system 780 (these are predetermined functions available with any existing finger print sensor reader unit) generates a finger print code characterizing the users finger print and sends them over via line 785 to the AWP finger print adapter unit 700 located in finger print detector unit 12. The finger print system 780 is supported by the housing 17 and is positioned to receive at least a portion of an individual's finger. The AWP finger print adapter unit 700 has a print code converter 710 that converts the users finger prints into the predetermined codes using predetermined algorithms selected by the proximity service provider 20 and sends these codes to the print code unit 720 via line 715. The print code unit 720 provides these signals to the protocol unit 170 via line 725 which in turn sends them to the existing legacy unit 180 via line 172. The legacy unit 180 then transmits these codes to the various proximity service providers 20 via transmissions 21, 23, 25, 27 or other service centers not shown. The finger print coded information is thus made available to the proximity service providers 20 for validation and authorization purposes.

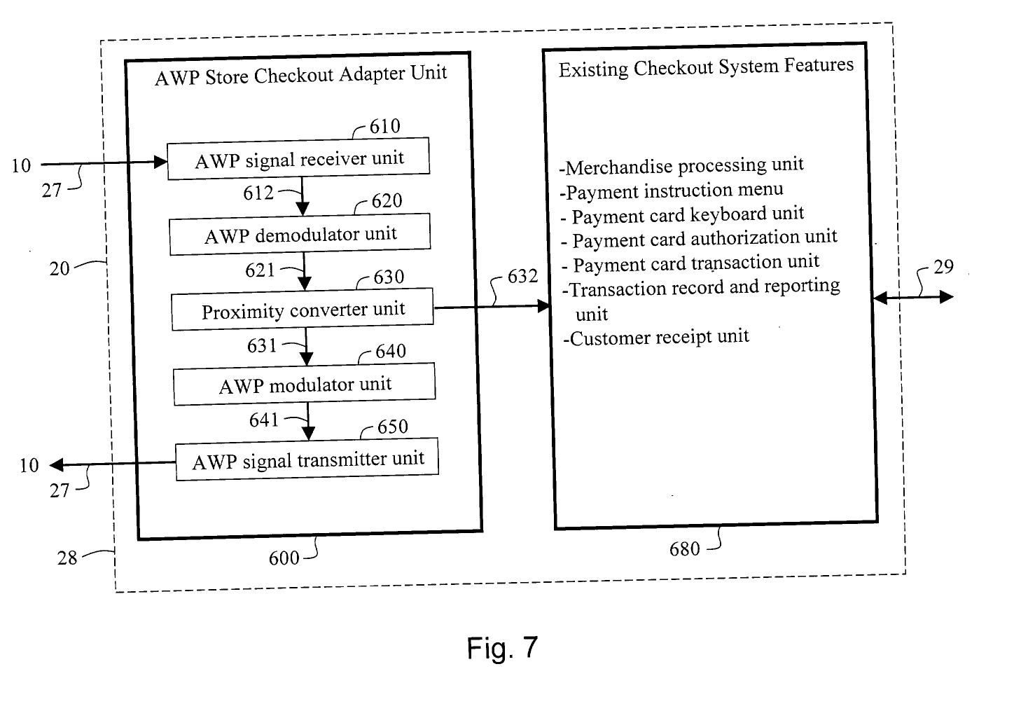

The AWPS 5 can be utilized as follows. The proximity service provider 20 can be the store checkout station 28 located at a point of use such as a grocery store for example. In this embodiment, the user carries the AWP unit 10 into the grocery store and then selects at least one product for purchase. The user transports the AWP unit 10 and the products to the store checkout station 28. The UPC code on the product is entered into the store checkout station 28, such as by scanning the UPC code with a suitable scanner. The UPC or unique code identifying the product can be batched in the store checkout station 28 while the UPC codes of other products are entered into the store checkout station or otherwise until the user's transaction is complete. A product checkout price is requested from the user for payment. The user then actuates the proximity services mode switch 110 (FIG. 2) to cause the AWP unit 10 to download the personal information code and predetermined protocols to the AWP store checkout adapter unit 600 of the checkout station 28 as discussed above with reference to FIGS. 2 and 7. If additional security is desired, the user can place one of his fingers on the finger print system 780 (FIG. 8) to generate the unique codes which are indicative of the user's fingerprint. The unique codes can then be downloaded or transmitted to the AWP store checkout adapter unit 600 as discussed above. The operation of the AWP unit 10 and the store checkout station 28 has been discussed above and will not be repeated for sake of brevity.

In any event, the personal information code, predetermined protocols, and possibly the unique fingerprint code, are transmitted from the store checkout station 28 to a third party, such as a credit card company, for automated payment verification as indicated by the line 29. If the personal information code and unique fingerprint code are valid and the transaction is authorized, the third party transmits a signal to this effect to the store checkout station 28 via the link 29 and the transaction will be effected.

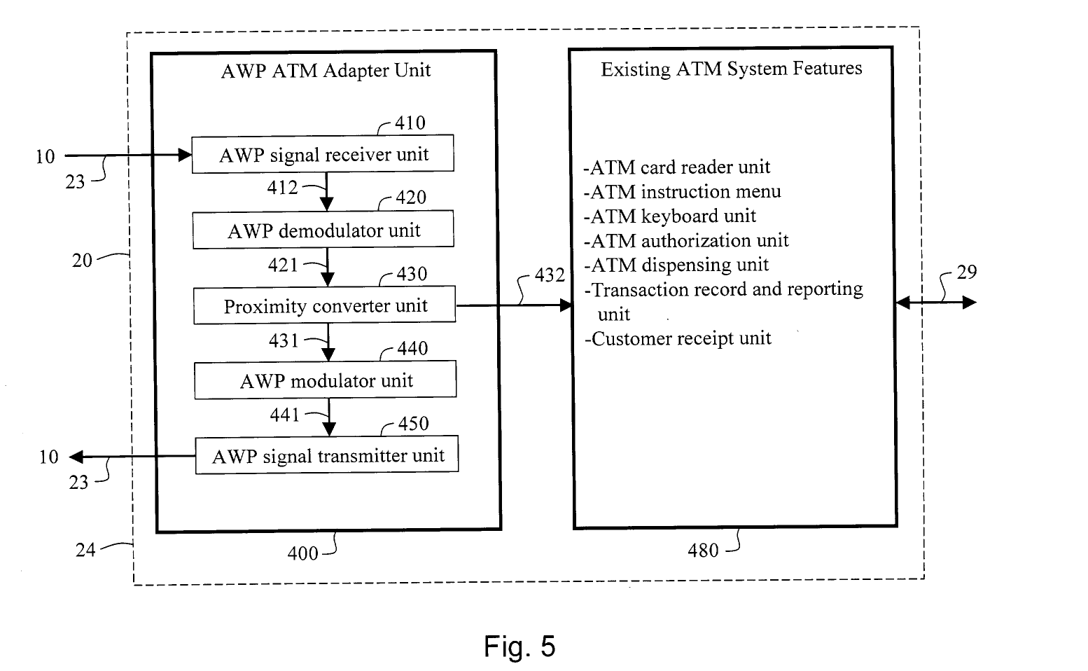

As discussed above, the proximity service provider 20 can be the ATM unit 24. In this embodiment, the AWPS 5 can be utilized as follows. The user transports the AWP unit 10 to the ATM unit 24. The user then actuates the proximity services mode switch 110 (FIG. 2) to cause the AWP unit 10 to download the personal information code and other predetermined protocols to the AWP ATM adapter unit 400 of the ATM unit 24 as discussed above with reference to FIGS. 2 and 5. If additional security is desired, the user can place one of his fingers on the finger print system 780 (FIG. 8) to generate the unique codes which are indicative of the user's fingerprint. The unique codes can then be downloaded or transmitted to the AWP store checkout adapter unit 400 as discussed above. The operation of the AWP unit 10 and the ATM unit 24 has been discussed above and will not be repeated for sake of brevity. The user then enters in a withdrawal amount into the ATM keyboard unit and a pin number, if desired. The personal information code, withdrawal amount, and possibly the unique fingerprint code or the pin number, are transmitted from the ATM unit 24 to a third party, such as a bank, for automated payment verification as indicated by the line 29.

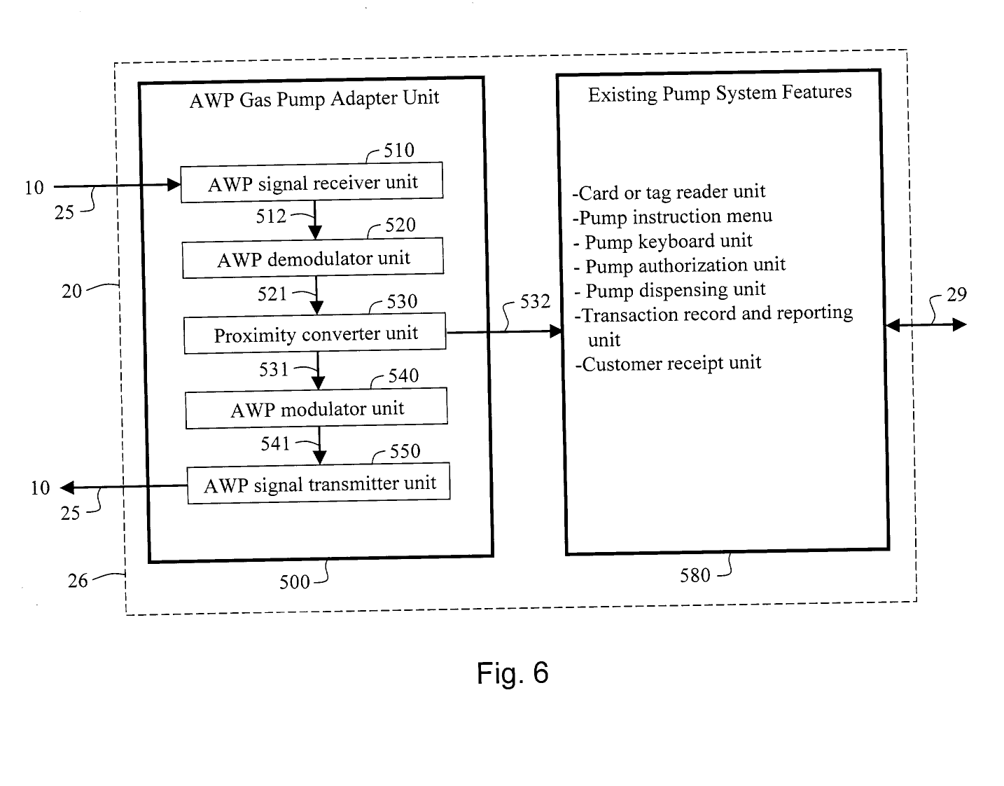

The processes for utilizing the AWP unit 10 with the toll booth 22, and the gas station pump 26 are similar to the processes for utilizing the AWP unit 10 with the ATM unit 24 and the store checkout station 28, except as described hereinafter. When the AWP unit 10 is being utilized with the toll booth 22, the auto activate mode unit 115 in the AWP unit 10 is turned on via link 1 16 when a signal is received by a T/R available signal detector unit located in the existing legacy phone capabilities 180. The personal information code and predetermined protocols are then transmitted to the toll booth unit 22 for automatic accounting of the toll booth charges, as discussed above. When the AWP unit 10 is being utilized with the gas station pump 26, the user transmits the personal information codes and predetermined protocols to the gas station pump 26 via the link 25 as best shown in FIGS. 1 and 6. The gas station pump 26 then transmits the personal information codes and predetermined protocols to a third party, such as a credit card company, via the link 29 for payment authorization prior to the pumping of the gas. When authorization is received, the gas station pump 26 is actuated to permit the user to pump the gas into his gas tank.

While the AWP unit 10 is communicating with the toll booth 22, the ATM unit 24, the gas station pump 26, or the store checkout station 28 (proximity service providers 20) the AWP unit 10 may also be communicating with the communication service provider 45 to permit the user to place telephone calls, receive pages, or receive and respond to e-mail, for example.

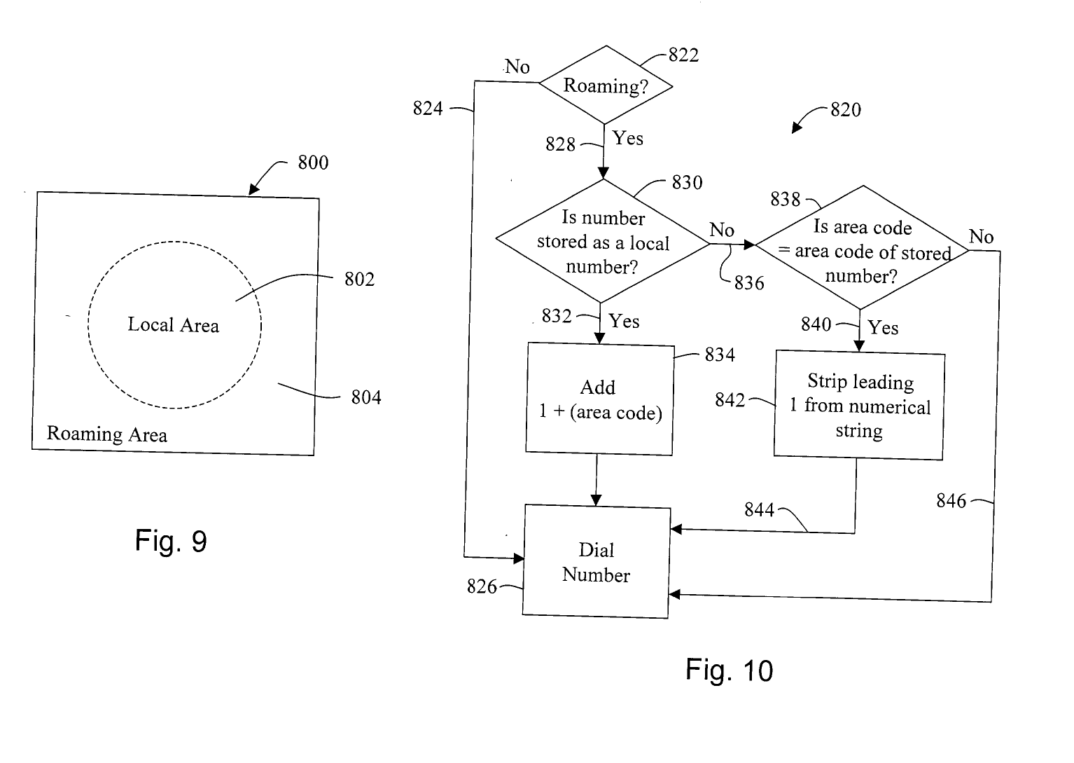

Referring now to FIG. 9, a geographical territory 800 has been characterized as having a local area 802 and a roaming area 804. The roaming area 804 is located outside the local area 802. Conventionally, communication service providers 45 require or do not require the use of dialing prefix codes, such as billing (“1” or “0”) or area codes, based upon the location of the telephone within the geographical territory 800. For example, if the telephone is located in the local area 802 and the telephone is being used to call a number associated with the local area 802, a prefix, such as “1” or “0” preceding the number, may not be required. However, when the telephone is located outside the local area 802 (i.e. the roaming area 804) and the telephone code or number being dialed is associated with the local area, a prefix such as “1” or “0” and an area code preceding the telephone code number may be necessary.

In the embodiment depicted in FIG. 2, the AWP unit 10 includes the legacy digital computer 180. The digital computer 180 is adapted to determine whether the AWP unit 10 is positioned in the roaming area 804 or the local area 802. In accordance with the present invention, the digital computer 180 is programmed to add a predetermined prefix, such as the number one plus the area code, to a local telephone code stored in the memory unit of the AWP unit 10, in response to the determination that the AWP unit 10 is currently positioned in the roaming area 804. The digital computer 180 may also be adapted to determine whether the AWP unit 10 is positioned in the roaming area 804 and to remove the predetermined prefix, such as the number one plus the area code, the predetermined prefix being stored in the memory unit and running on the digital computer 180, from the long-distance telephone code responsive to the determination that the AWP unit 10 is positioned in the roaming area 804.

Referring now to FIG. 10, the logic flow diagram for the computer program telephone dialing system 820 is shown. After the individual selects the local telephone code for dialing, the first step 822 is to determine the location of the AWP unit 10. Where the AWP unit 10 is located within the local area 802, the process branches 824 to the dialing step 826 and the local telephone code is dialed. Where it is determined that the AWP unit 10 is located in the roaming area 804, the process branches to a step 830 as indicated by the line 828. At the step 830, the characteristics of the stored number are determined. The determination that the stored number is a local telephone code causes the process to branch to step 834 as indicated by the line 832. At the step 834, the digital computer 180 adds a predetermined prefix, such as the number one and the area code associated with the local telephone code, to the local telephone code. The corresponding prefix, such as the area code, may have been previously entered and stored within the digital computer 180. Thereafter, the program branches to the step 826 to dial the local telephone code with the prefix added. However, where the characteristics of the stored number 830 result in the determination that the stored number is non-local, the process branches to a step 838 as indicated by the line 836.

The step 838 determines whether the predetermined prefix for the long-distance telephone code, such as the area code, matches the prefix for the long-distance telephone code applicable to the roaming area 804 where the AWP unit 10 is currently located. This may be accomplished, for example, by the digital computer 180 communicating with the communication service provider 45 during the communication session when determining the location of the AWP unit 10. Where the codes are equivalent, such as where the area code prefix of the stored long-distance telephone code matches the area code of the current location of the AWP unit 10, the process branches to a step 842 as indicated by the line 840. At the step 842, the prefix, such as the number one and the area code, is removed from the long-distance telephone code. Then, the modified long-distance telephone code is dialed at the step 826 as indicated by the line 844.

Where the step 838 determines that the predetermined prefix for the long-distance telephone code of the stored number, such as the area code, does not match the prefix for the long-distance telephone code applicable to the roaming area 804 where the AWP unit 10 is currently located, the process branches to the step 826 to dial the long-distance telephone code as it was stored in the digital computer 180 of the AWP unit 10, as indicated by the line 846.

Changes may be made in the steps or sequence of steps or the construction or operation or mode methods described herein without departing from the spirit and the scope of the invention as defined in the following claims.

What is claimed is:

1. A system for providing a predetermined service to effect a transaction, comprising:
a plurality of proximity service providers, each of the proximity service providers adapted to provide a different predetermined service, each of the proximity service providers comprising:
a proximity receiver unit for receiving at least one personal information code;
an output unit receiving the personal information code from the proximity receiver unit for outputting the personal information code to a third party to obtain validation before providing the predetermined service to effect the transaction;
a wireless unit separate from the proximity service provider, the wireless unit comprising:
a portable housing adapted to be carried by an individual;
a memory unit supported by the housing, the memory unit storing, prior to initiation of the transaction, at least one personal information code in a manner capable of being retrieved; and
a communication unit supported by the housing for receiving information from a communication service provider and for retrieving and outputting the personal information code to the proximity receiver unit of the proximity service provider, without effecting the communication service provider, to activate the proximity service provider and thereby effect the transaction.

2. The system as defined in claim 1, wherein at least two separate personal information codes are stored in the memory unit and wherein the communication unit is further defined as outputting one of the personal information codes selected by the individual.

3. The system as defined in claim 1, wherein the wireless unit includes a telephone transmitter unit for transmitting the information to the communication service provider.

4. The system as defined in claim 3, wherein the communication unit includes a high power transmitter mode for communicating with the communication service provider and a low power transmitter mode for outputting the personal information code to the proximity service provider located within a predetermined proximity distance.

5. The system as defined in claim 1, further comprising a fingerprint detector unit supported by the housing and positioned to receive at least a portion of an individual's finger so as to selectively generate a fingerprint code indicative of at least a portion of the fingerprint of the individual.

6. The system as defined in claim 1, wherein the communication unit is capable of about simultaneously outputting signals to the communication service provider and the proximity service provider located within a predetermined proximity distance.

7. The system as defined in claim 1, wherein the wireless unit is a telephone.

8. The system as defined in claim 1, wherein the wireless unit is a pager.

9. A method for providing a predetermined service to effect a transaction, comprising:
transporting, by an individual, a wireless unit in close proximity to one of a plurality of proximity service providers with each proximity service provider adapted to provide a different predetermined service upon activation;
storing at least one personal information code in a manner capable of being retrieved in a memory unit of the wireless unit;
communicating, via the wireless unit, with a communication service provider after the personal information code is stored in the memory unit of the wireless unit;
outputting, via the wireless unit, the personal information code to the proximity service provider, without effecting the communication service provider;
receiving, via the proximity service provider, the personal information code output by the wireless unit; and
outputting, via the proximity service provider, the personal information code to a third party to obtain validation before providing the predetermined service.

10. The method defined in claim 9, wherein at least two separate personal information codes are stored in the memory unit and wherein the method further comprises the step of selecting, by the individual, one of the personal information codes.

11. The method as defined in claim 9, wherein the step of communicating, via the wireless unit, is further defined as communicating via a telephone transmitter unit of the wireless unit for communicating with the communication service provider.

12. The method as defined in claim 11, wherein the method is further defined as the communicating with the communication service provider in a high power transmitter mode and outputting, via the wireless unit, the personal information code to the proximity service provider in a low-power mode.

13. The method as defined in claim 9, further comprising the step of positioning the individual's finger on a fingerprint detector unit supported by the wireless unit and selectively generating a fingerprint code indicative of at least a portion of the fingerprint of the individual.

14. The method as defined in claim 9, wherein the steps of communicating and outputting occur about simultaneously.

15. The method as defined in claim 9, wherein the wireless unit is a telephone.

16. The method as defined in claim 9, wherein the wireless unit is a pager.

17. A method for providing communication services, comprising the steps of:
converting, via a wireless telephone, voice and keyboard information to be transmitted to a communication service provider located remotely from the wireless telephone via a telephone transmitter unit;
receiving information by a telephone receiver unit of the wireless telephone from the communication service provider;
outputting the information received by the telephone receiver unit in a format perceivable by an individual;
storing at least one personal information code in a manner capable of being retrieved in the wireless telephone;
transporting the wireless unit in close proximity to one of a plurality of proximity service providers with each proximity service provider adapted to provide a different predetermined service upon activation;
outputting, via the wireless telephone, the personal information code to one of the proximity service providers, without effecting the communication service provider, whereby upon receipt of the personal information code the proximity service provider is activated to provide a predetermined service.

18. The method as defined in claim 17, further comprising the step of inserting at least one personal information code into the memory unit from a location remote from the wireless telephone.

19. The method as defined in claim 17, further comprising the steps of automatically receiving a proximity service code from one of the proximity service providers, and automatically outputting the personal information code responsive to the reception of the proximity service code.

20. The method as defined in claim 17, wherein the proximity service provider is further defined as a toll booth unit.

21. The method as defined in claim 17, wherein the proximity service provider is further defined as a store checkout station.

22. The method as defined in claim 17, wherein the proximity service provider is further defined as an ATM unit.

23. The method as defined in claim 17, wherein the proximity service provider is further defined as a gas station pump unit.
